(19) United States
(12) Patent Application Publication
(10) Pub. No.: US 2008/0303857 A1
(43) Pub. Date: Dec. 11, 2008

(54) NOZZLE CHIP CLEANING APPARATUS OF INKJET PRINTER, INKJET PRINTER USING THE SAME, AND METHOD THEREOF

(75) Inventor: Karp-sik YOUN, Hawaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/872,133

(22) Filed: Oct. 15, 2007

(30) Foreign Application Priority Data
Jun. 5, 2007 (KR) 2007-55264

(51) Int. Cl. B41J 2/165; B08B 3/02; B08B 3/12

(52) U.S. Cl. 347/28; 134/1; 134/184; 134/201; 134/34; 134/42; 134/62

(57) ABSTRACT

A nozzle chip cleaning apparatus of an inkjet printer in which a structure to supply and drain a cleaning solution to clean nozzle chips. The nozzle chip cleaning apparatus includes a cleaning bath in which a cleaning solution is contained to clean the nozzle chips, an ultrasonic wave device installed in the cleaning bath to generates waves in the cleaning solution contained in the cleaning bath so that the cleaning solution reaches the nozzle chips, a supply and drain pipe that performs as a supply pipe to supply the cleaning solution from a cleaning solution storage tank to the cleaning bath and as a drain pipe to drain the cleaning solution that has been supplied to the cleaning bath to the cleaning solution storage tank, and a pump that provides a driving force to supply and drain the cleaning solution through the supply and drain pipe. According to the above configuration, since the supply and drain of the cleaning solution is performed using one supply and drain pipe, a space that is occupied by the pipe can be reduced, thereby reducing a size of the inkjet printer.

### CROSS-REFERENCE TO RELATED APPLICATIONS

This application claims priority under 35 U.S.C. § 119(a) from Korean Patent Application No. 10-2007-0055264, filed on Jun. 5, 2007, in the Korean Intellectual Property Office, the disclosure of which is incorporated herein in its entirety by reference.

### BACKGROUND OF THE INVENTION

1. Field of the Invention

The present general inventive concept relates to a nozzle chip cleaning apparatus of an inkjet printer and a method thereof, and more particularly, to a nozzle chip cleaning apparatus of an inkjet printer, in which a structure to supply and drain a cleaning solution to clean nozzles is improved, an inkjet printer using the same, and a method thereof.

2. Description of the Related Art

A conventional inkjet printer is an apparatus for printing a predetermined image on desired locations of a paper by ejecting ink droplets through a nozzle chip, and can be classified into a shuttle type and an array type according to the type of inkjet head that ejects the ink droplets. The shuttle type prints an image by reciprocally moving an inkjet head having a single nozzle chip in a widthwise direction, and the array type prints an image in a line unit by arranging a plurality of nozzle chips in a widthwise direction of a paper. Recently, the array type inkjet printer is widely used due to its high printing speed.

When the printing work is repeated using the inkjet head, ejection holes can be blocked due to, for example, ink stuck around the ejection holes of the nozzle chips. In this case, since ink droplets cannot be ejected through the ejection holes, a desired image cannot be printed. Thus, in order to address this problem, a conventional nozzle chip cleaning apparatus for cleaning the ejection holes of the nozzle chips when it is necessary is included in the inkjet head, the conventional nozzle chip cleaning apparatus wipes the ejection holes using a predetermined cleaning solution, and has a structure as depicted FIG. 1. In FIG. 1, an inkjet head 20 is an array type, and a cleaning bath 11 is installed to reciprocally move along the widthwise direction of a paper so that the cleaning bath 11 can clean a plurality of nozzle chips 21 arranged in the widthwise direction of the paper. The conventional nozzle chip cleaning apparatus further includes a supply pipe 14 that supplies a cleaning solution into the cleaning bath 11, a drainpipe 15 that returns the cleaning solution used in the cleaning bath 11, and an ultrasonic wave device 12. When cleaning the nozzle chips 21 using the conventional nozzle chip cleaning apparatus having the above structure, the cleaning solution is supplied to the cleaning bath 11 through the supply pipe 14, and operating the ultrasonic wave device 12 generates vibration. Accordingly, the cleaning solution that enters the cleaning bath 11 is generated into waves as illustrated in FIG. 1, and the waves of the cleaning solution touch the nozzle chips 21, and thus, ejection holes 21a of the nozzle chips 21 are cleaned. When the cleaning of the ejection holes 21a is finished, the cleaning solution that is used for cleaning the nozzle chips 21 is recovered into a storage tank 13 through the drainpipe 15.

However, in the conventional nozzle chip cleaning apparatus as described above, the supply pipe 14, for supplying the cleaning solution to the cleaning bath 11, and the drain pipe 15, for recovering the cleaning solution, must be respectively installed and separately connected to the pump p and the cleaning bath 11. Therefore, the conventional nozzle chip cleaning apparatus has a complicated structure and occupies a large space in the inkjet printer, and thus, it is inconvenient in terms reducing the size of the inkjet printer. Also, since the cleaning solution in the cleaning bath 11 must not overflow during the cleaning of the ejection holes 21a, a high precision part such as a level sensor 16 for detecting the level of the cleaning solution must be installed and managed.

Therefore, in order to address the above problems, there is a need to develop a method of controlling the supply and drain of the cleaning solution and the level of the cleaning solution with a simple structure.

### SUMMARY OF THE INVENTION

The present general inventive concept provides a nozzle chip cleaning apparatus that has a simple structure to control the supply and drain of a cleaning solution to clean nozzle chips, and an inkjet printer that uses the nozzle chip cleaning apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing nozzle chip cleaning apparatus including a cleaning bath in which a cleaning solution is contained to clean nozzle chips of an inkjet head, an ultrasonic wave device installed in the cleaning bath to generate waves in the cleaning solution contained in the cleaning bath so that the cleaning solution reaches the nozzle chips of the inkjet head, a supply and drain pipe to supply the cleaning solution from a cleaning solution storage tank to the cleaning bath and to drain the cleaning solution that has been supplied to the cleaning bath into the cleaning solution storage tank and a pump to provide a driving force to supply and drain the cleaning solution through the supply and drain pipe.

The foregoing and/or other aspects and utilities of the present general inventive concept may also be achieved by providing an inkjet printer including an inkjet head that forms an image by ejecting ink droplets onto a printing medium through nozzle chips and a nozzle chip cleaning apparatus for cleaning the nozzle chips, wherein the nozzle chip cleaning apparatus includes a cleaning bath in which a cleaning solution is contained to clean nozzle chips, an ultrasonic wave device installed in the cleaning bath to generate waves in the cleaning solution contained in the cleaning bath so that the cleaning solution reaches the nozzle chips, a supply and drain pipe that performs as a supply pipe to supply the cleaning solution from a cleaning solution storage tank to the cleaning bath and as a drain pipe to drain the cleaning solution that has been supplied to the cleaning bath to the cleaning solution storage tank, and a pump that provides a driving force to supply and drain the cleaning solution through the supply and drain pipe.

The cleaning bath may include an inner cleaning bath in which the ultrasonic wave device is formed and an outer cleaning bath that surrounds the inner cleaning bath to contain the cleaning solution that overflows from the inner cleaning bath.

The inkjet printer may further include a one directional valve between the outer cleaning bath and the supply and drain pipe to block the cleaning solution from entering the outer cleaning bath when supplying the cleaning solution and to allow the cleaning solution to flow into the supply and drain pipe from the outer cleaning bath when draining the cleaning solution.

A plurality of ultrasonic wave devices each having a size corresponding to that of each of the nozzle chips may be formed to simultaneously clean the nozzle chips formed on the inkjet head. One ultrasonic wave device may have a size to be able to simultaneously clean the nozzle chips.

The cleaning bath may be installed to be able to move along a widthwise direction of a printing medium.

The foregoing and/or other aspects and utilities of the present general inventive concept may also be achieved by providing an inkjet printer, including an inkjet head including a plurality of nozzle chips to eject ink onto a printing medium to form an image thereon, and a nozzle chip cleaning apparatus, including a cleaning storage tank to store a cleaning solution, a plurality of cleaning baths to receive the cleaning solution from the cleaning storage tank to clean the plurality of nozzle chips, and a supply and drain pipe to transport the cleaning solution back and forth between the cleaning storage tank and the plurality of cleaning baths.

The inkjet printer may further include a one directional valve to prevent the cleaning solution from entering one of the plurality of cleaning baths when the cleaning solution is supplied to another one of the plurality of cleaning baths through the supply and drain pipe.

The one directional valve may include an open-close member to block a first connection hole on a side of the one of the plurality of cleaning baths to prevent the cleaning solution from entering the one of the plurality of cleaning baths through the first connection hole when the cleaning solution is supplied to the another one of the plurality of cleaning baths.

The one directional valve may the open-close member to block a second connection hole on a side of the supply and drain pipe to allow the cleaning solution to drain through the supply and drain pipe through a third connection hole formed on a side of the one directional valve.

At least one of the plurality of cleaning baths captures the cleaning solution if it overflows from another one of the plurality of cleaning baths.

The inkjet printer may further include a pump to pump in a first direction to supply the cleaning solution to the plurality of cleaning baths from the cleaning storage tank and to pump in a second direction to supply the cleaning solution from the plurality of cleaning baths back to the cleaning storage tank.

The inkjet printer may further include a plurality of ultrasonic wave devices to each correspond to each of the nozzle chips such that the plurality of ultrasonic wave devices simultaneously clean the nozzle chips formed on the inkjet head.

The inkjet printer may further include an ultrasonic wave device having a size to simultaneously clean each of the nozzle chips.

The foregoing and/or other aspects and utilities of the present general inventive concept may also be achieved by providing a method of cleaning a plurality of nozzle chips of an inkjet printer head, the method including supplying a cleaning solution to a cleaning bath from a cleaning storage tank using a supply and drain pipe, cleaning the plurality of nozzle chips in the cleaning bath with the cleaning solution, capturing overflowing cleaning solution in another cleaning bath, and supplying the cleaning solution from the cleaning bath and the another cleaning bath back to the cleaning storage tank using the supply and drain pipe.

The cleaning of the nozzle chips may be performed by generating ultrasonic waves in the cleaning solution.

The method may further include operating a pump in a first direction to supply the cleaning solution to the cleaning bath from the cleaning storage tank; and operating the pump in a second direction to supply the cleaning solution from the cleaning bath and the another cleaning bath back to the cleaning storage tank.

The foregoing and/or other aspects and utilities of the present general inventive concept may also be achieved by providing an inkjet printer, including an inkjet head including a plurality of nozzle chips to eject ink onto a printing medium to form an image thereon, a nozzle chip cleaning apparatus including a cleaning storage tank to store a cleaning solution, first and second cleaning baths to receive the cleaning solution from the cleaning storage tank, and a pipe unit having a single supply and drain pipe connected to the cleaning storage tank, a first pipe connected between the supply and drain pipe and the first cleaning bath, and a second pipe connected between the supply and drain pipe and the second cleaning bath.

The first cleaning bath may be disposed within the second cleaning bath such that the second cleaning bath receives the cleaning solution from the first cleaning bath.

The pipe unit may include a one-directional valve disposed on the second pipe to allow a flow of the cleaning solution from the second cleaning bath to the single supply and drain pipe through the second pipe.

The supply and drain pipe may be connected to the first and second pipes through a connector.

The second pipe may include a first bath pipe and a second bath pipe connected to a first hole and a second hole of the first bath.

The second pipe may further include a first connector and a second connector connected between the second pipe and the second bath pipe.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view of a conventional nozzle chip cleaning apparatus;

FIG. 2 is a perspective view of an inkjet printer having a nozzle chip cleaning apparatus according to an embodiment of the present general inventive concept;

FIG. 3 is a perspective view of the nozzle chip cleaning apparatus of FIG. 2, according to an embodiment of the present general inventive concept;

FIG. 4 is a perspective view of the magnified cleaning bath of the nozzle chip cleaning apparatus of FIG. 3, according to an embodiment of the present general inventive concept;

FIGS. 5A and 5B are cross-sectional views illustrating an operation of a one directional valve of FIG. 4, according to an embodiment of the present general inventive concept;

FIGS. 6A through 6D are schematic drawings illustrating a process of supplying and draining a cleaning solution to and from the nozzle chip cleaning apparatus of FIG. 3, according to an embodiment of the present general inventive concept; and

FIGS. 7A and 7B are schematic drawings illustrating modifications of an ultrasonic wave device of the nozzle chip cleaning apparatus of FIG. 3, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

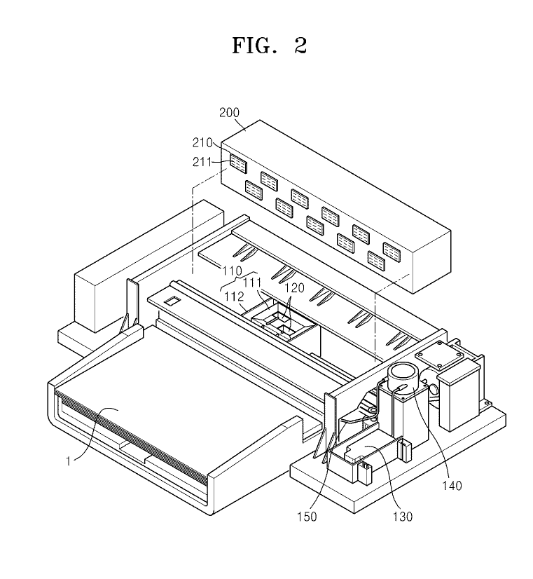

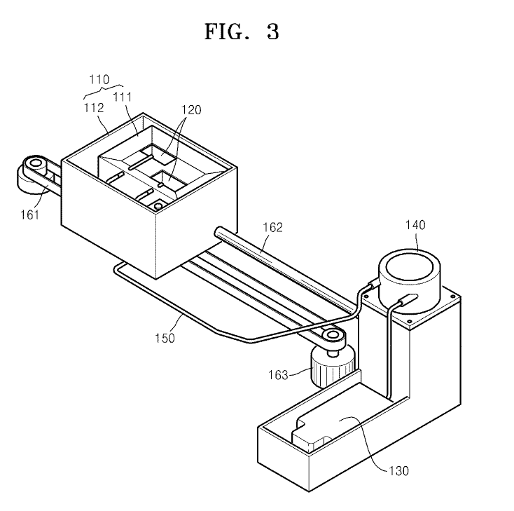

FIG. 2 is a perspective view of an inkjet printer having a nozzle chip cleaning apparatus according to an embodiment of the present general inventive concept, and FIG. 3 is a perspective view of the nozzle chip cleaning apparatus of FIG. 2, according to an embodiment of the present general inventive concept.

In the embodiment of FIGS. 2 and 3, the nozzle chip cleaning apparatus including an array type inkjet printer 200 in which a plurality of nozzle chips 210 are arranged in a widthwise direction of a paper 1, which is a printing medium, will now be described.

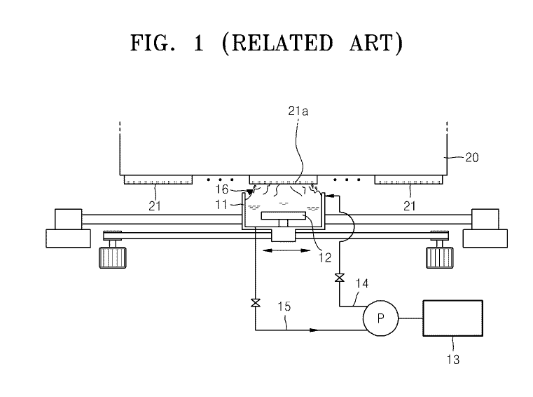

The array type inkjet printer 200 includes a cleaning bath 110 in which an ultrasonic wave device 120 is built, a cleaning solution storage tank 130 in which a cleaning solution is stored, and a pump 140 to supply and recover the cleaning solution to and from the cleaning bath 110 that cleans the nozzle chips 210 of the array type inkjet printer 200. The ultrasonic wave device 120 may be provided in plurality. When cleaning of the nozzle chips 210 is necessary, the cleaning solution stored in the cleaning solution storage tank 130 is supplied to the cleaning bath 110 by operating the pump 140. Accordingly, the ultrasonic wave devices 120 are operated to generate waves in the cleaning solution that has entered the cleaning bath 110, and thus, a plurality of ejection holes 211 of the nozzle chips 210 are cleaned as described with reference to FIG. 1. When the cleaning of the ejection holes 211 of the nozzle chips 210 is completed, the pump 140 is operated in an opposite pumping manner so as to recover the cleaning solution that was supplied to the cleaning bath 110 into the cleaning solution storage tank 130. The array type inkjet printer 200 further includes a driving belt 161 that is driven by a motor 163 to reciprocally move the cleaning bath 110 in a widthwise direction of the paper 1, and a guide rail 162 that guides the reciprocal movement of the cleaning bath 110. Thus, in order to clean the nozzle chips 210 included in the array type inkjet printer 200, the cleaning bath 110 reciprocally moves in a span where the nozzle chips 210 are disposed. If the inkjet printer is a shuttle type printer in which a print head moves in a widthwise direction of the paper 1, a cleaning operation can be performed by moving the cleaning bath 110 after the cleaning bath 110 is fixed on a side end of the inkjet printer.

In the embodiment of FIGS. 2 and 3, a structure to supply and drain the cleaning solution is improved as follows. A supply and drain pipe 150 is included as a single line to supply and recover the cleaning solution of the cleaning solution storage tank 130 to and from the cleaning bath 110. That is, instead of separately including a supply pipe and a drain pipe as two distinct units the single supply and drain pipe 150 is provided in the embodiment of FIGS. 2 and 3 of the present general inventive concept. The single supply and drain pipe 150 is connected to the pump 140. Thus, the cleaning solution is supplied to the cleaning bath 110 from the cleaning solution storage tank 130 along the supply and drain pipe 150, and also, the cleaning solution is recovered from the cleaning bath 110 to the cleaning solution storage tank 130 along the supply and drain pipe 150, as will be described later in detail.

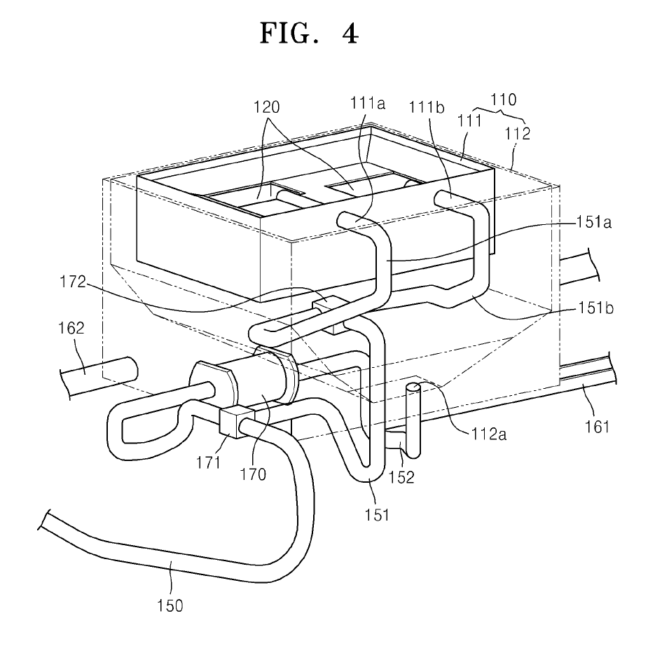

As depicted in FIGS. 3 and 4, the cleaning bath 110 has a double structure of an inner cleaning bath 111 and an outer cleaning bath 112. The inner cleaning bath 111, where the ultrasonic wave devices 120 are formed, receives the cleaning solution supplied from the cleaning solution storage tank 130. The outer cleaning bath 112 that surrounds the inner cleaning bath 111 accommodates the cleaning solution that overflows from the inner cleaning bath 111. Thus, this structure allows the cleaning bath 110 to control a level of the cleaning solution in the cleaning bath 110 without a need to include an additional sensor. That is, during the cleaning process, the cleaning solution is continuously supplied to the inner cleaning bath 111 from the cleaning solution storage tank 130 and the cleaning solution that overflows from the inner cleaning bath 111 is temporarily stored in the outer cleaning bath 112. As such, the cleaning process can be performed without using a level sensor. The outer cleaning bath 112 is formed to have a capacity in consideration of the cleaning solution that is supplied during the cleaning process.

Referring to FIG. 4, a pipe unit is connected between the pump 140 and the cleaning bath 110, and includes the single supply and drain pipe 150 connected to the pump 140, a first pipe 151 connected between the supply and drain pipe 150 and the inner cleaning bath 111, and a second pipe 152 connected between the supply and drain pipe 150 and the outer cleaning bath 112 by a connector 171. The first pipe 151 is connected by a connector 172 to the inner cleaning bath 111, as well as a first inner pipe 151a which is connected to a first inner bath hole 111a and a second inner pipe 151b which is connected to a second inner bath hole 111b. The second pipe 152 is also connected to a first outer bath hole 112a.

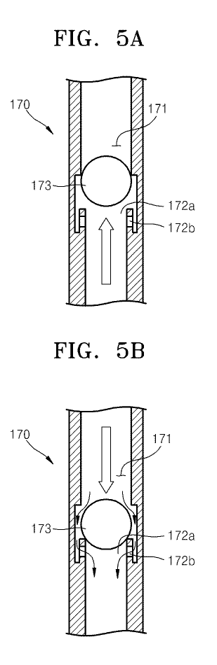

The nozzle chip cleaning apparatus includes a one directional valve 170 that prevents the cleaning solution from entering the outer cleaning bath 112 when the cleaning solution is supplied to the inner cleaning bath 111 through the supply and drain pipe 150, and allows the cleaning solution in the outer cleaning bath 112 to be drained through the supply and drain pipe 150 when the cleaning solution is drained. That is, as depicted in FIG. 5A, when supplying the cleaning solution, an open-close member 173 that is built in the one directional valve 170 blocks a connection hole 171 on a side of the outer cleaning bath 112 due to a flow of the cleaning solution, and thus, the cleaning solution cannot enter the outer cleaning bath 112 through the connection hole 171. In contrast, when draining the cleaning solution, as depicted in FIG. 5B, the open-close member 173 blocks a first connection hole 172a on a side of the supply and drain pipe 150 due to the flow of the cleaning solution. Thus, the cleaning solution can be drained through the supply and drain pipe 150 through a second connection hole 172b formed on a side of the one directional valve 170.

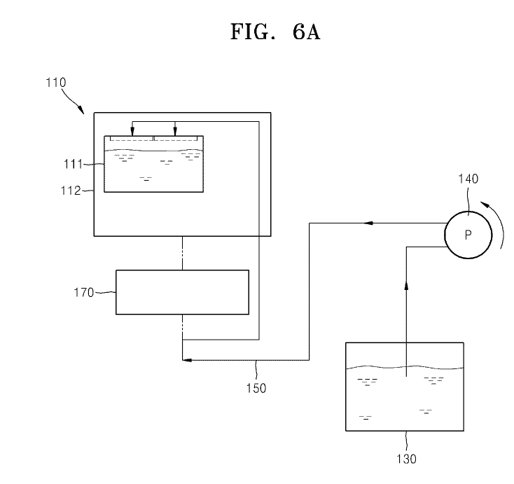

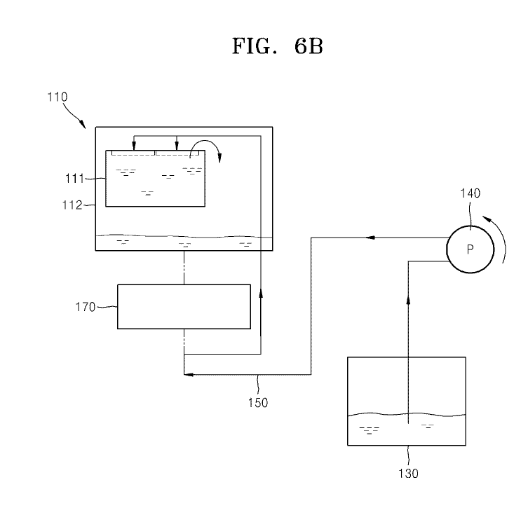

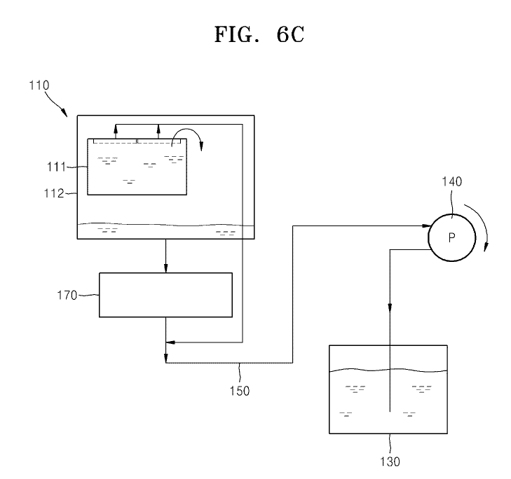

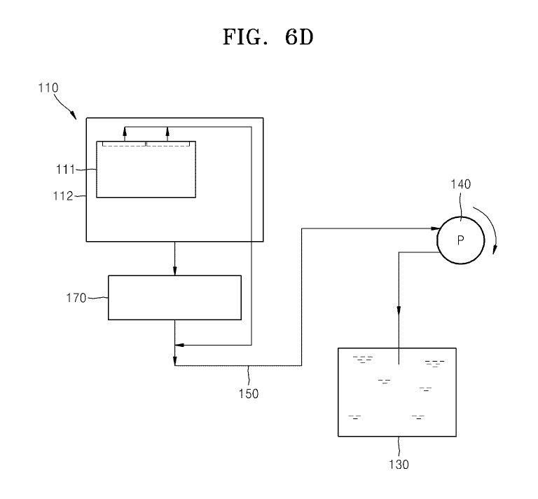

The cleaning process using the nozzle chip cleaning apparatus having the above configuration is performed as illustrated in FIGS. 6A through 6D. In FIGS. 6A through 6D, constituent elements are expressed in simple blocks to easily understand the cleaning process, mainly in terms of supplying and draining the cleaning solution.

In order to perform the cleaning process, the cleaning bath 110 is moved directly below the nozzle chips 210 that are to be cleaned. As described above, if the inkjet head is an array type, the cleaning bath 110 is moved along the guide rail 162 as the driving the motor 163 turns the belt 161. If the inkjet head is a shuttle type, the inkjet head is moved above the cleaning bath 110 in preparation of the cleaning operation.

Afterwards, when the cleaning of the nozzle chips 210 begins, as depicted in FIG. 6A, the pump 140 is operated to supply the cleaning solution to the cleaning bath 110 from the cleaning solution storage tank 130 through the supply and drain pipe 150. Accordingly, the cleaning solution enters the inner cleaning bath 111 and the cleaning solution cannot enter the outer cleaning bath 112, since the supply and drain pipe 150 is blocked by the one directional valve 170. At this point, the ultrasonic wave device 120 in the inner cleaning bath 111 is operated to generate waves in the cleaning solution. As a result, the nozzle chips 210 are cleaned by the waves of the cleaning solution as described above.

When the cleaning solution is supplied to the inner cleaning bath 111 beyond a capacity of the inner cleaning bath 111 during the cleaning process, as depicted in FIG. 6B, the cleaning solution that overflows from the inner cleaning bath 111 is collected in the outer cleaning bath 112. Therefore, the cleaning process can be smoothly performed even though a level of the cleaning solution in the inner cleaning bath 111 is not controlled using an additional level sensor since the cleaning solution that overflows is safely stored in the outer cleaning bath 112.

When the cleaning process is completed, as depicted in FIG. 6C, the cleaning solution that has been supplied to the cleaning bath 110 is recovered by reversely operating the pump 140. At this point, as described with reference to FIG. 5B, the cleaning solution contained in the outer cleaning bath 112 can pass through the one directional valve 170, and thus, the cleaning solutions contained in both the inner cleaning bath 111 and the outer cleaning bath 112 enter the cleaning solution storage tank 130 through the supply and drain pipe 150.

Then, as depicted in FIG. 6D, until the next cleaning process, the cleaning solution is stored in the cleaning solution storage tank 130.

As described above, the supply and drainage of the cleaning solution can be performed using the single supply and drain pipe 150 without performing a complicated level control using a sensor.

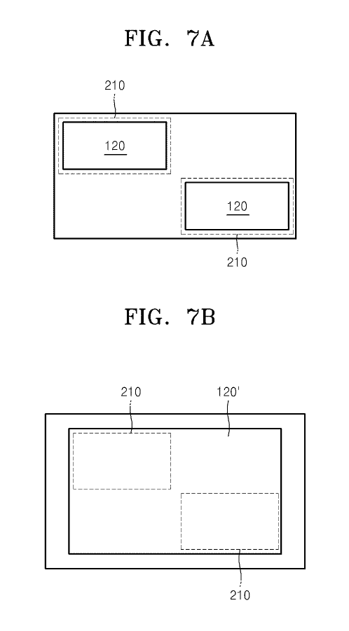

The present embodiment is configured with two ultrasonic wave devices 120 that are installed in the inner cleaning bath 111, and thus, as depicted in FIG. 7A, the two ultrasonic wave devices 120 respectively correspond to the two nozzle chips 210. However, as depicted in FIG. 7B, the present embodiment can be configured to cover the two nozzle chips 210 with one large ultrasonic wave device 120′.

As described above, a nozzle chip cleaning apparatus of an inkjet printer according to an embodiment of the present general inventive concept has the following advantages.

First, the supply and drainage of a cleaning solution can be performed using a single supply and drain pipe. Thus, a space that is occupied by the pipes can be reduced, thereby reducing a size and weight of the inkjet printer.

Second, a double cleaning bath is used to prevent an overflow of the cleaning solution. Therefore, a complicated level control of the cleaning solution using an additional high precision level sensor is unnecessary.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A nozzle chip cleaning apparatus, comprising:
a cleaning bath in which a cleaning solution is contained to clean nozzle chips of an inkjet head;
a cleaning solution storage tank to store a cleaning solution;
a supply and drain pipe to transport the cleaning solution back and forth between the cleaning storage tank and the cleaning bath.

2. The nozzle chip cleaning apparatus of claim 1, further comprising:
an ultrasonic wave device installed in the cleaning bath to generate waves in the cleaning solution contained in the cleaning bath so that the cleaning solution reaches the nozzle chips of the inkjet head.

3. The nozzle chip cleaning apparatus of claim 2, further comprising:
a pump to provide a driving force to supply and drain the cleaning solution through the supply and drain pipe.

4. The nozzle chip cleaning apparatus of claim 1, wherein the cleaning bath comprises:
an inner cleaning bath in which the ultrasonic wave device is formed; and
an outer cleaning bath to surround the inner cleaning bath to contain the cleaning solution that overflows from the inner cleaning bath.

5. The nozzle chip cleaning apparatus of claim 4, further comprising:
a one directional valve between the outer cleaning bath and the supply and drain pipe to block the cleaning solution from entering the outer cleaning bath when supplying the cleaning solution and to allow the cleaning solution to flow into the supply and drain pipe from the outer cleaning bath when draining the cleaning solution.

6. The nozzle chip cleaning apparatus of claim 2, wherein each of a plurality of ultrasonic wave devices has a size corresponding to that of each of the nozzle chips and are formed to simultaneously clean the nozzle chips formed on the inkjet head.

7. The nozzle chip cleaning apparatus of claim 2, wherein one ultrasonic wave device has a size to simultaneously clean each of the nozzle chips.

8. The nozzle chip cleaning apparatus of claim 1, wherein the cleaning bath is installed to move along a widthwise direction of a printing medium.

9. An inkjet printer comprising:
an inkjet to form an image by ejecting ink droplets onto a printing medium through nozzle chips and a nozzle chip cleaning apparatus to clean the nozzle chips,
wherein the nozzle chip cleaning apparatus comprises:
a cleaning bath in which a cleaning solution is contained to clean the nozzle chips;
a cleaning solution storage tank to store a cleaning solution;
a supply and drain pipe to transport the cleaning solution back and forth between the cleaning storage tank and the cleaning bath.

10. The inkjet printer of claim 9, wherein the cleaning bath comprises:
an ultrasonic wave device installed in the cleaning bath to generate waves in the cleaning solution contained in the cleaning bath so that the cleaning solution reaches the nozzle chips of the inkjet head.

11. The inkjet printer of claim 10, wherein the cleaning bath comprises:
a pump to provide a driving force to supply and drain the cleaning solution through the supply and drain pipe.

12. The inkjet printer of claim 9, wherein the cleaning bath comprises:
an inner cleaning bath in which the ultrasonic wave device is formed; and
an outer cleaning bath to surround the inner cleaning bath to contain the cleaning solution that overflows from the inner cleaning bath.

13. The inkjet printer of claim 12, further comprising;
a one directional valve between the outer cleaning bath and the supply and drain pipe to block the cleaning solution from entering the outer cleaning bath when supplying the cleaning solution and to allow the cleaning solution to flow into the supply and drain pipe from the outer cleaning bath when draining the cleaning solution.

14. The inkjet printer of claim 9, wherein each of a plurality of ultrasonic wave devices has a size corresponding to each of the nozzle chips and the plurality of ultrasonic wave devices are formed to simultaneously clean the nozzle chips formed on the inkjet head.

15. The inkjet printer of claim 9, wherein one ultrasonic wave device has a size to simultaneously clean each of the nozzle chips.

16. The inkjet printer of claim 9, wherein the cleaning bath is installed to move along a widthwise direction of a printing medium.

17. A method of cleaning a plurality of nozzle chips of an inkjet printer head, the method comprising:
supplying a cleaning solution to a cleaning bath from a cleaning storage tank using a supply and drain pipe;
cleaning the plurality of nozzle chips in the cleaning bath with the cleaning solution;
capturing overflowing cleaning solution in another cleaning bath; and
supplying the cleaning solution from the cleaning bath and the another cleaning bath back to the cleaning storage tank using the supply and drain pipe.

18. The method of claim 17, wherein the cleaning of the nozzle chips is performed by generating ultrasonic waves in the cleaning solution.

19. The method of claim 17, further comprising:
operating a pump in a first direction to supply the cleaning solution to the cleaning bath from the cleaning storage tank; and
operating the pump in a second direction to supply the cleaning solution from the cleaning bath and the another cleaning bath back to the cleaning storage tank.

20. An inkjet printer, comprising:
an inkjet head comprising a plurality of nozzle chips to eject ink onto a printing medium to form an image thereon; and
a nozzle chip cleaning apparatus comprising:
a cleaning storage tank to store a cleaning solution;
first and second cleaning baths to receive the cleaning solution from the cleaning storage tank, and
a pipe unit having a single supply and drain pipe connected to the cleaning storage tank, a first pipe connected between the supply and drain pipe and the first cleaning bath, and a second pipe connected between the supply and drain pipe and the second cleaning bath.

21. The inkjet printer of claim 20, wherein the first cleaning bath is disposed within the second cleaning bath such that the second cleaning bath receives the cleaning solution from the first cleaning bath.

22. The inkjet printer of claim 20, wherein the pipe unit comprises a one-directional valve disposed on the second pipe to allow a flow of the cleaning solution from the second cleaning bath to the single supply and drain pipe through the second pipe.

23. The inkjet printer of claim 20, wherein the supply and drain pipe is connected to the first and second pipes through a connector.

24. The inkjet printer of claim 20, wherein the second pipe comprises a first bath pipe and a second bath pipe connected to a first hole and a second hole of the first bath.

25. The inkjet printer of claim 23, wherein the second pipe further comprises a first connector and a second connector connected between the second pipe and the second bath pipe.
